(19) United States
(12) Patent Application Publication
(10) Pub. No.: US 2026/0302649 A1
(43) Pub. Date: Oct. 1, 2026

(54) RADIO FREQUENCY DEVICES AND SYSTEMS INCLUDING RADIO FREQUENCY DEVICES

(71) Applicant: Infineon Technologies AG, Neubiberg (DE)

(72) Inventors: Ernst SELER, Riemerling (DE); Tuncay ERDÖL, Unterhaching (DE)

(21) Appl. No.: 19/442,099

(22) Filed: Jan. 7, 2026

(30) Foreign Application Priority Data
Mar. 27, 2025 (DE) 102025112053.6

(51) Int. Cl. H01Q 21/26; H01Q 1/22; H01Q 5/335

(52) U.S. Cl. CPC H01Q 21/26; H01Q 1/2283; H01Q 5/335

(57) ABSTRACT

A radio frequency (RF) device includes at least one RF chip and a structure coupled to the at least one RF chip, wherein the at least one RF chip and the structure are integrated in a same semiconductor package. The structure is configured to couple at least two RF signals of the at least one RF chip to at least two modes of a package-external waveguide and/or vice versa. The structure includes a metal layer including an opening and one or more metal elements arranged in the opening.

### CROSS-REFERENCE TO RELATED APPLICATION

This application claims priority to Germany Patent Application No. 102025112053.6 filed on Mar. 27, 2025, the content of which is incorporated by reference herein in its entirety.

### TECHNICAL FIELD

The present disclosure relates to radio frequency (RF) devices and systems including RF devices.

### BACKGROUND

In RF technology, such as automotive radar, the trend is towards more and more performance-oriented solutions. In this regard, the number of transmit (TX) and receive (RX) channels of RF devices is steadily increased, usually resulting in large package sizes. Manufacturers and developers of RF devices and systems including RF devices are constantly striving to improve their products. In the above context, it may be desirable to provide RF devices and systems of smaller size and lower production costs without compromising performance values.

### SUMMARY

An aspect of the present disclosure relates to an RF device. The RF device includes at least one RF chip and a structure coupled to the at least one RF chip, wherein the at least one RF chip and the structure are integrated in a same semiconductor package. The structure is configured to couple at least two RF signals of the at least one RF chip to at least two modes of a package-external waveguide and/or vice versa. The structure includes a metal layer including an opening and one or more metal elements arranged in the opening.

A further aspect of the present disclosure relates to a system. The system includes an RF device including at least one RF chip and a structure coupled to the at least one RF chip, wherein the at least one RF chip and the structure are integrated in a same semiconductor package. The structure is configured to couple at least two RF signals of the at least one RF chip to at least two modes of a package-external waveguide and/or vice versa. The structure includes a metal layer including an opening. The system further includes a printed circuit board including a first main surface and an opposite second main surface. The RF device is mounted on the first main surface. The printed circuit board includes a quad ridge waveguide extending through the printed circuit board from the first main surface to the second main surface. The quad ridge waveguide is aligned with the opening of the metal layer.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIGS. 1A to 1E schematically illustrate a cross-sectional side view and various details of an RF device 100 in accordance with the disclosure.

FIGS. 2A to 2C schematically illustrate details of an RF device in accordance with the disclosure.

FIGS. 3A to 3D schematically illustrate a cross-sectional side view and various details of a system 300 in accordance with the disclosure.

FIG. 4 schematically illustrates a top view of a quad ridge waveguide formed in a PCB.

FIG. 5 schematically illustrates a bottom view of a system 500 in accordance with the disclosure.

### DETAILED DESCRIPTION

In the following detailed description, reference is made to the accompanying drawings, in which are shown by way of illustration specific aspects in which the disclosure may be practiced. Other aspects may be utilized and structural or logical changes may be made without departing from the concept of the present disclosure. Hence, the following detailed description is not to be taken in a limiting sense, and the concept of the present disclosure is defined by the appended claims.

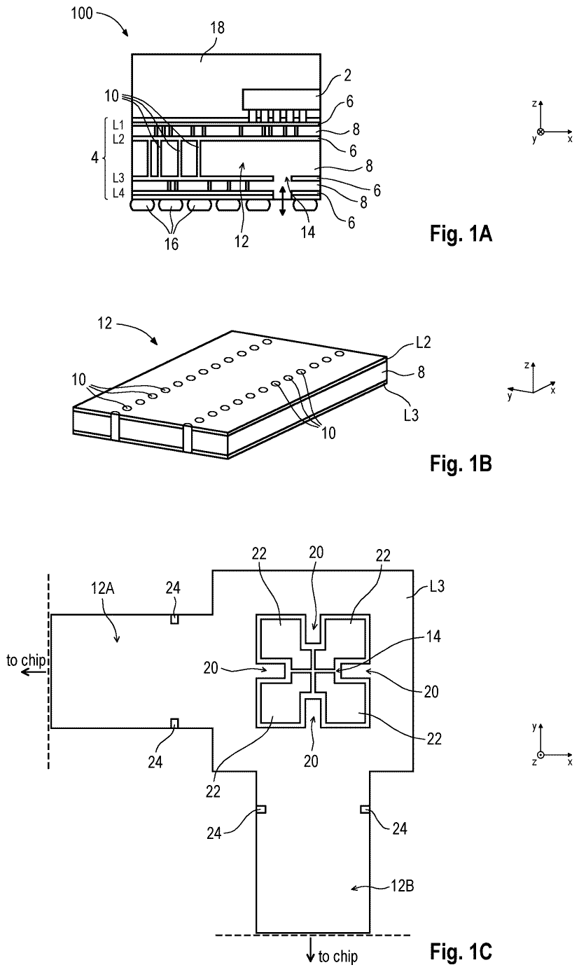

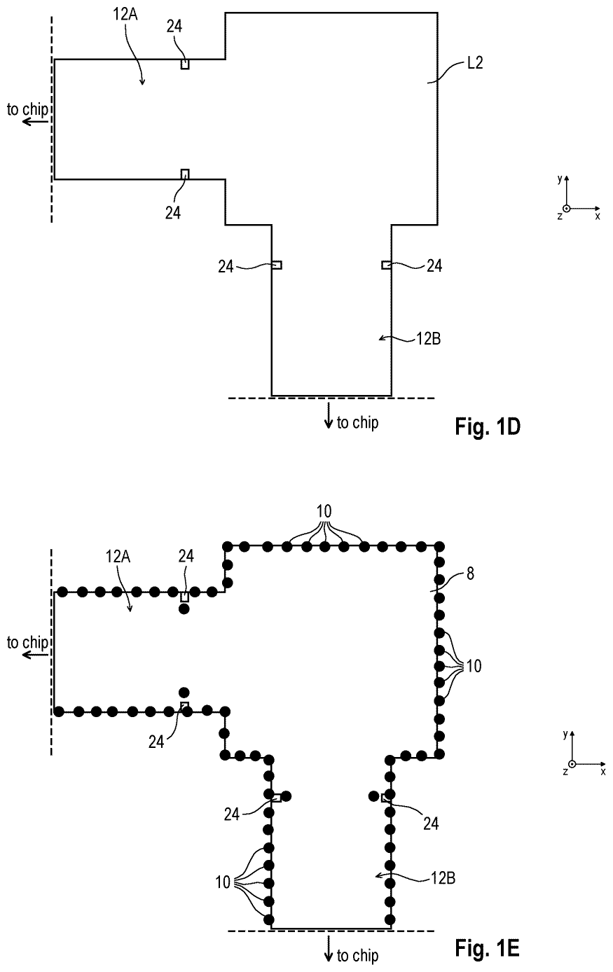

FIG. 1A illustrates a cross-sectional side view of an RF device 100 in accordance with the disclosure. The RF device 100 may include at least one RF chip 2 configured to provide or support at least one TX channel for transmitting RF signals and/or at least one RX channel for receiving RF signals. In the illustrated example, a single RF chip 2 is shown, but it is to be noted that the RF device 100 may include additional RF chips, the number of which may depend on a specific design of the RF device 100. The RF chip 2 may be made of or may include an arbitrary semiconductor material, such as e.g., silicon. The RF chip 2 (or electronic circuits thereof) may be configured to operate in a frequency range of greater than about 1 GHz, in some examples greater than about 10 GHz. Accordingly, the RF chip 2 may also be referred to as radio frequency chip or high frequency chip or microwave frequency chip. More particular, the RF chip 2 may be configured to operate in an RF range or microwave frequency range, which may range from about 1 GHz to about 1 THz, more particular from about 10 GHz to about 300 GHz. Microwave circuits may include, for example, microwave transmitters, microwave receivers, microwave transceivers, microwave sensors, microwave detectors, or the like. RF devices in accordance with the disclosure may be used for radar applications in which the frequency of the RF signals may be modulated. The RF chip 2 may thus also be referred to as radar chip. In particular, the RF chip 2 may include or may correspond to an MMIC (Monolithic Microwave Integrated Circuit).

Radar microwave devices may e.g., be used in automotive, industrial, military and/or defense applications for range and speed measuring systems. For example, automotive applications may include advanced driver assistant systems, automatic vehicle cruise control systems, vehicle anti-collision systems, or the like. Such systems may operate in the microwave frequency range and may utilize FMCW (Frequency Modulation Continuous Wave) signals, for example in the 24 GHz, 76 GHz, or 79 GHz frequency bands. A use of radar microwave systems may provide constant and efficient driving of vehicles. An efficient driving style may reduce fuel consumption such that CO₂ emission may be reduced and energy savings may be enabled. In addition, abrasion of vehicle tires, brake discs and brake pads may be reduced, thereby reducing fine dust pollution. Improved RF or radar systems, as described herein, may thus contribute to green technology solutions, e.g., climate-friendly solutions providing reduced energy usage.

In the illustrated example, the RF device 100 may correspond to or may include a flip-chip package, but is not restricted thereto. The RF chip 2 may be mounted on a top surface of a substrate 4. The substrate 4 may include multiple metal layers 6 (see L1 to L4) which may e.g., be made of or may include copper or a copper alloy. In addition, the substrate 4 may include multiple dielectric layers 8 arranged between the multiple metal layers 6. For example, the dielectric layers 8 may made of or may include one or multiple dielectric glue layers. The metal layers 6 and the dielectric layers 8 may substantially extend in a direction parallel to a main surface of the RF chip 2. The metal layers L2 and L3 may be electrically connected in the vertical direction by multiple via connections 10. Optionally, similar via connections may provide an electrical connection in the vertical direction between the metal layers L1 and L2 and/or between the metal layers L3 and L4.

In the shown case, the RF device 100 may include at least one package-internal transmission structure in form of at least one substrate integrated waveguide (SIW) 12. The package-internal transmission structure may be configured to transmit mm-wave signals in particular. It is to be noted that package-internal transmission structures as described herein are not restricted to SIWs. Alternatively, the package-internal transmission structures may include or may correspond to at least one of e.g., an air-filled waveguide, a planar transmission line, or the like. A planar transmission line may include or may correspond to at least one of e.g., a microstrip line, a coplanar waveguide, a ground-signal-ground line, or the like. In the example side view of FIG. 1A, only one SIW 12 is shown due to the chosen perspective, but as can be seen from FIGS. 1C to 1E described later on, more than only one SIWs may be included in the RF device 100.

An example perspective view of the SIW 12 is shown in the perspective view of FIG. 1B. The SIW 12 may include the metal layers L2 and L3 as well as a dielectric layer 8 arranged between the metal layers L2 and L3. In addition, the SIW 12 may include a plurality of via connections 10 extending between the metal layers L2 and L3. The via connections 10 may be arranged to form a via fence. The SIW 12 may be formed by the dielectric layer 8 covered on both faces by the metal layers L2 and L3. The dielectric layer 8 may embed the via connections 10 that may form two parallel rows of metallic via holes delimiting a propagation area of RF signals (e.g., electromagnetic waves) that are to be transmitted via the SIW 12. The propagating electromagnetic waves may be confined within the dielectric layer 8 by the metal layers L2 and L3 on each of the two surfaces of the dielectric layer 8 as well as between the two rows of metallic vias 10 connecting the metal layers L2 and L3. In the illustrated example, the SIW 12 may be configured to transmit electromagnetic waves in a lateral direction (here: x-direction).

The RF device 100 may include a structure coupled to the RF chip 2 and configured to couple at least two RF signals of the RF chip 2 to at least two modes of a package-external waveguide (not shown) and/or vice versa. The package-external waveguide is not restricted to a specific type and may e.g., include or correspond to at least one of a metal waveguide, a substrate integrated waveguide, an air-filled waveguide, a dielectric waveguide, a plastic microwave fiber, etc. In a specific example described later on, the package-external waveguide may include or may correspond to a quad ridge waveguide formed in a printed circuit board and/or an air-filled waveguide formed in a waveguide antenna. In the following, the structure may also be referred to as coupling structure, transmission/reception structure or launcher structure.

The structure may include a metal layer having an opening and one or more metal elements arranged in the opening. In the illustrated example, the structure may include the metal layers L3 and/or L4 including an opening 14 arranged therein. In the example side view of FIG. 1A, the metal elements arranged in the opening 14 are not shown for the sake of simplicity. However, a more detailed of the opening and the metal elements arranged therein will be described later on in connection with FIG. 1C. In the shown case, the structure may be arranged inside and at the bottom surface of the substrate 4 and may be configured to transmit and/or receive RF signals in a substantially vertical direction. A respective coupling of RF signals from the structure into an external waveguide and/or vice versa is exemplarily indicated by a bidirectional vertical arrow in FIG. 1A. In the illustrated side view of the RF device 100, a single structure is shown, but it is to be understood that the RF device 100 may include an arbitrary number of structures depending on specific design of the RF device 100.

During an operation of the RF device 100, the at least two RF signals of the RF chip 2 may be transmitted to the structure or the opening 14 via the at least one SIW 12. In this context, the RF device 100 may include at least one planar transmission line (such as a coplanar waveguide, not shown) which may be at least partially formed in the metal layers L1 and/or L2 and may be configured to couple the RF chip 2 and the SIW 12. For example, an RF signal may be coupled from the planar transmission line into the SIW 12 via a slot antenna (not shown) that may be formed in the metal layer L2. The coupling structure may then transmit the RF signals received from the SIW 12 into a package-external waveguide, such as e.g., a waveguide antenna. In a similar fashion, the RF device 100 may receive RF signals during an operation, for example by coupling the RF signals from a package-external waveguide to the coupling structure. The received RF signals may be forwarded to the RF chip 2 via the SIW 12 and the planar transmission line formed in the metal layer L1 and/or L2.

Referring now to FIG. 1C, a more detailed design of the structure for coupling the RF signals of the RF chip 2 to the modes of a package-external waveguide and/or vice versa is shown. More particular, FIG. 1C illustrates a top view of the metal layer L3 at the position of the structure (note: if the RF device 100 includes the (optional) metal layer L4, then FIG. 1C may correspond to a top view of the metal layers L3 and/or L4). The structure may include the metal layer L3 with the opening 14 formed therein. In the illustrated example, the opening 14 may include or may correspond to a quad ridge shaped opening. The quad ridge shaped opening 14 may have the shape of a cross section of a quad ridge waveguide. In this context, the opening 14 may have the shape of a rectangle comprising a notch 20 in each side of the rectangle. In particular, the notches 20 may be substantially arranged in the center of the respective side of the rectangle.

A quad ridge waveguide may correspond to a rectangular waveguide including four additional ridges. The shape of a quad ridge waveguide may be primarily rectangular, similar to a conventional rectangular waveguide, but with the addition of four ridges for modifying its internal structure. The main body of a quad ridge waveguide may have a rectangular cross-section, wherein a defining feature of the quad ridge waveguide may be the additional presence of the four ridges. In particular, there may be two ridges situated on the top inner surface and two on the bottom inner surface of the waveguide. The four ridges may extend parallel to the length of the waveguide. Each ridge may have a certain height and width, wherein their dimensions may be engineered to optimize performance and bandwidth of the quad ridge waveguide. The exact dimensions of the ridges may vary, but should fit within the constraints of the total width and height of the overall rectangular waveguide.

The structure may include one or more metal elements 22 arranged in the opening 14. In the illustrated example, an example number of four metal elements 22 may be arranged in the opening 14, wherein each of the four metal elements 22 may be arranged in a different corner of the rectangle. In the shown case, all metal elements 22 may have a similar shape. However, in further examples, the shape of at least two metal elements 22 may differ. The contour of the metal elements 22 may at least partially extend substantially parallel to the contour of the opening 14. A distance between the metal elements 22 and the contour of the opening 14 may be substantially constant. In particular, the metal elements 22 may include or may correspond to structured portions of the metal layer L3. That is, the metal elements 22 may be manufactured when structuring the metal layer L3. In such case, the material of the metal elements 22 and the metal layer L3 may be the same.

In the shown case, the metal elements 22 may be separated and electrically isolated from each other. In addition, the metal elements 22 may be separated and electrically isolated from (in particular all) other portions of the metal layer L3. That is, the metal elements 22 may be (in particular completely) embedded in the dielectric material 8 of the substrate 4. Each of the metal elements 22 may be electrically floating, e.g., have a floating electrical potential. A floating potential may refer to the electric potential of a conductive object that is not directly connected to a reference point, such as ground, and is thus free to change in response to its surrounding electric fields.

In the example of FIG. 1C, a first package-internal transmission structure in form of a first SIW 12A may extend in a first direction (here: x-direction), and a second package-internal transmission structure in form of a second SIW 12B may extend in a second direction orthogonal to the first direction (here: y-direction). A bottom layer of the SIWs 12A, 12B may be formed by the metal layer L3 as shown in the perspective view of FIG. 1B. Each of the SIWs 12A, 12B may be configured to transmit RF signals between the chip (see “to chip”) and the structure or opening 14. The RF signals transmitted by the SIWs 12A, 12B may be associated with different RF channels of the RF chip 2. In the illustrated example, the SIWs 12A, 12B may be of a similar type with similar waveguide parameters. Due to their orthogonal arrangement, a mode of the first SIW 12A transmitting the first RF signal may be orthogonal to a mode of the second SIW 12 transmitting the second RF signal. The structure may be configured to couple the two RF signals from the SIWs 12A, 12B to two orthogonal modes of a package-external waveguide and/or vice versa. That is, the structure or opening 14 may have the function of an antenna or a launcher configured to transmit RF signals from the RF chip 2 and/or vice versa. In particular, the two orthogonal modes of the package-external waveguide may be two orthogonal electromagnetic polarizations.

The coupling structure may be configured to transform an impedance of the package-internal transmission structure (e.g., an impedance of the SIWs 12A, 12B) to an impedance of the package-external waveguide. In particular, the size and the shape of the metal elements 22 may be chosen to support such impedance matching. It is to be noted that the impedances of the package-internal and package-external components may naturally depend on various factors, such as frequencies of the transmitted RF signals, type of the respective components (e.g., SIWs, air-filled waveguides, planar transmission lines), geometry of the respective components, size of the respective components, and so on. In general, an impedance matching provided by the structure may be improved by arranging the metal elements 22 in the opening 14 compared to cases in which no metal elements are arranged in the opening 14.

Optionally, each of the SIWs 12A, 12B may include one or more impedance matching elements 24. In the illustrated example, the matching elements 24 may include or may correspond to irises formed in the respective SIW. The irises may be formed by discontinuities or notches in the respective SIW. In particular, the irises may be arranged at opposite sides of the respective SIW. In the illustrated example, the irises may substantially extend into the respective SIW in a direction perpendicular to a transmission direction of the SIW. In addition to the impedance matching provided by the metal elements 22 as previously described the matching elements 24 may be configured for impedance matching and improving broadband performance.

Referring now to FIG. 1D, a top view of the metal layer L2 of the RF device 100 at the position of the structure is illustrated in more detail (note: if the RF device 100 includes the (optional) metal layer L1, then FIG. 1C may correspond a top view of the metal layers L1 and/or L2). The metal layer L2 may form a top layer of the SIWs 12A, 12B as shown in the perspective view of FIG. 1B. In the example of FIG. 1D, the metal layer L2 may be continuous and not necessarily include any openings. Similar to the metal layer L3 of FIG. 1C, the metal layer L2 may include the impedance matching elements 24 arranged at similar positions.

In FIG. 1E, a top view of the via connections 10 extending between the metal L3 of FIG. 1C and the metal layer L2 of FIG. 1D is shown. Similar to the perspective view of FIG. 1B, the via connections 10 extending through the dielectric material 8 may be arranged along or may define the sides of the SIWs 12A, 12B, thereby forming a via fence for confining propagating electromagnetic waves. In particular, the via connections 10 may run along the shape of the impedance matching elements 24. That is, at least one of the via connections 10 may be shifted inwards at the positions of the impedance matching elements 24.

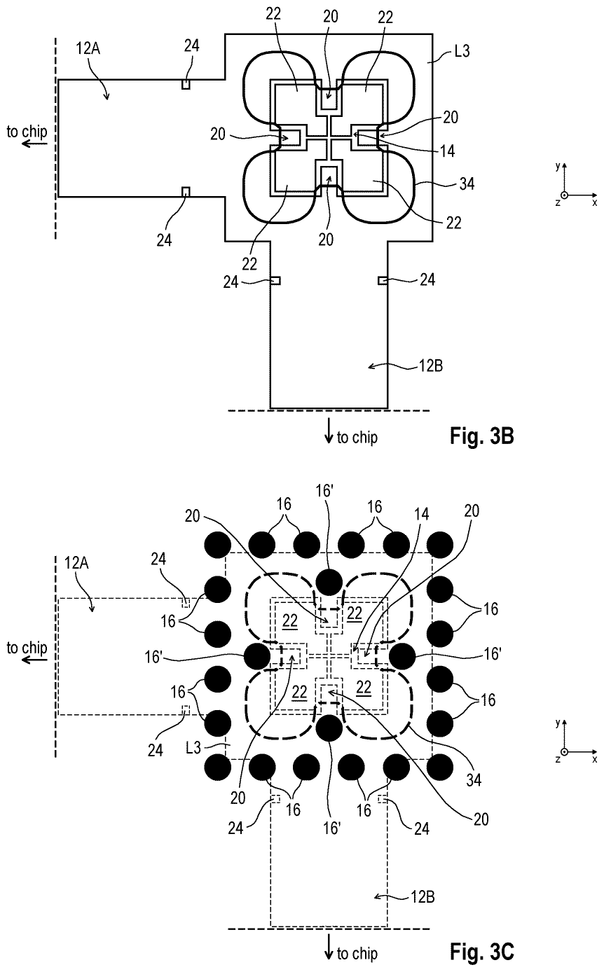

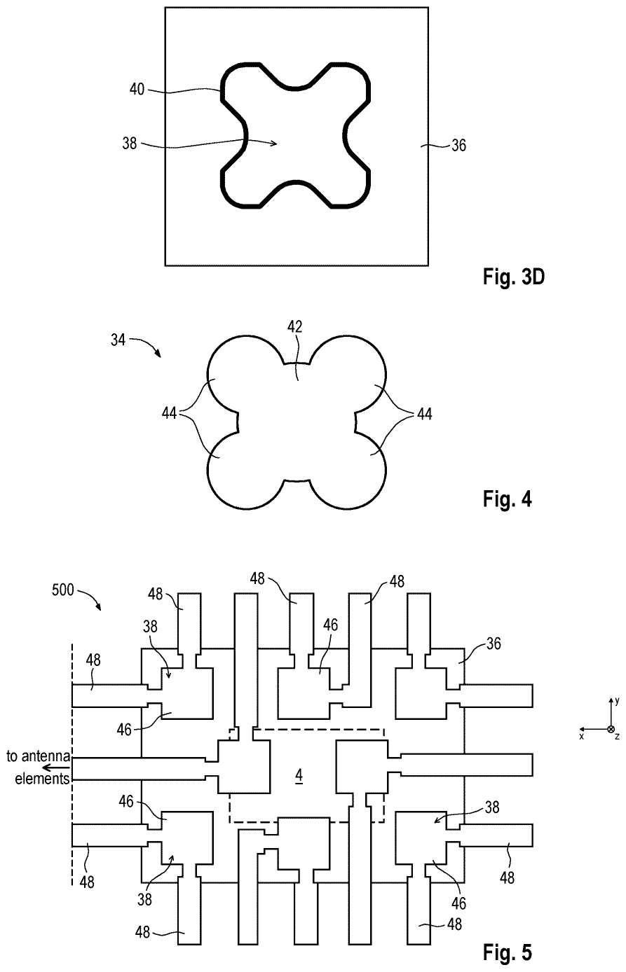

The RF device 100 may include further components, which are described in the following. For example, the RF device 100 may include connection elements 16 configured to connect the RF device 100 to an external component, such as e.g., a printed circuit board (PCB) as will be described later on in connection with the example of FIGS. 3A-3D. For example, the connection elements 16 may include or may correspond to solder balls or solder depots, but are not restricted thereto. Furthermore, the RF device 100 may optionally include an encapsulation material 18, which may at least partially encapsulate components of the RF device 100. In the illustrated example, the encapsulation material 18 may be arranged on the top surface of the substrate 4 and at least partially cover the RF chip 2. The encapsulation material 18 may include or may be made of at least one of an epoxy, a filled epoxy, a glass fiber filled epoxy, an imide, a thermoplast, a thermoset polymer, a polymer blend, a mold compound, or the like. Various techniques may be used for encapsulating components of the RF device 100 in the encapsulation material 18, for example at least one of compression molding, injection molding, powder molding, liquid molding, map molding, or the like. The RF device 100 may also be referred to as package or semiconductor package or RF package or RF semiconductor package. The RF chip 2 and the structure for coupling the RF signals of the RF chip 2 to the modes of a package-external waveguide may particularly be arranged in the same semiconductor package.

The RF device 100 may outperform conventional RF devices in various ways. The structure or opening 14 may represent an RF interface between the RF package 100 and a package-external waveguide. In particular, a structure including a quad ridge shaped opening may require a reduced area compared to, say, an interface between a package-internal standard dual polarized waveguide and a package-external waveguide. Here, the package-size of the RF device 100 may be reduced up to about 20% compared to conventional RF devices. Due to the reduced package size, a higher TCoB (thermal cycling on board) performance of the RF device 100 may be obtained. In addition, a resulting shorter electrical redistribution inside the package may lead to an improved RF signal channel-to-channel balance, lower losses in the package and thus an improved signal-to-noise ratio. Due to the space savings resulting from the use of a structure in accordance with the disclosure, the number of TX and RX channels supported by the RF device 100 may be increased without necessarily resulting in a large package size. The concepts presented herein thus provide RF devices and systems including RF devices with smaller size and lower production costs without compromising performance values.

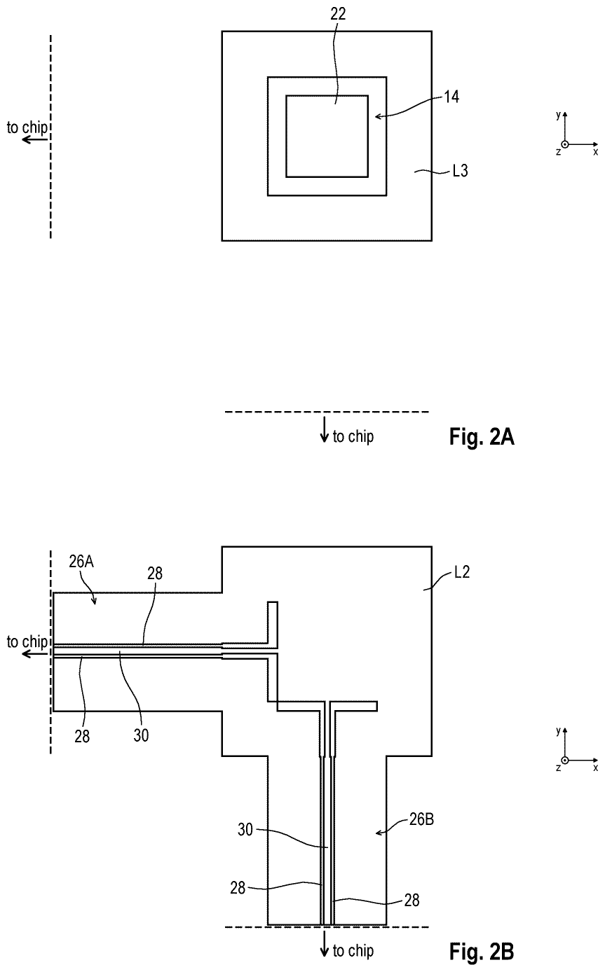

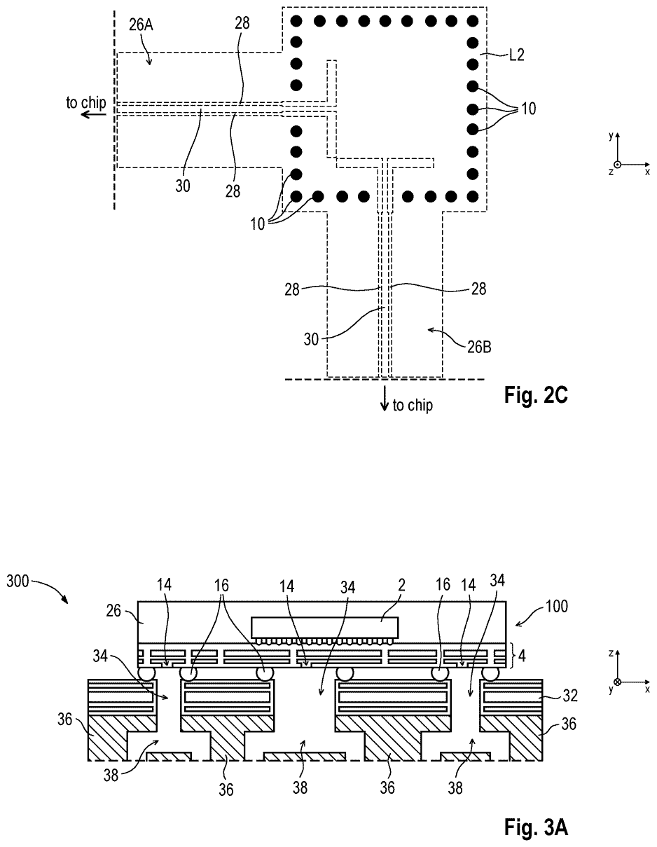

Referring now to FIGS. 2A to 2C, a further example of a structure for coupling RF signals of the RF chip 2 to a package-external waveguide and/or vice versa is shown. For example, the arrangement shown in FIGS. 2A to 2C may replace the arrangement previously described in connection with FIGS. 1C to 1E. In the example of FIGS. 2A-2C, the package-internal transmission structures of the RF device may include or may correspond to planar transmission lines 26A, 26B, such as e.g., coplanar waveguides.

FIG. 2A illustrates a top view of the metal layer L3 of the respective RF device at the position of the coupling structure (note: if the RF device includes the (optional) metal layer L4, then FIG. 2A may correspond a top view of the metal layers L3 and/or L4). Similar to the example of FIGS. 1A-1E, the structure may include the metal layer L3 having an opening 14 and at least one metal element 22 arranged therein. In the illustrated example, a single metal element 22 may be arranged in the opening 14. Here, each of the opening 14 and the metal element 22 may have a rectangular or square shape. The metal element 22 may provide an impedance matching function as previously described in connection with FIGS. 1A-1E.

FIG. 2B illustrates a top view of the metal layer L2 of the RF device at the position of the structure (note: if the RF device includes the (optional) metal layer L1, then FIG. 2B may correspond a top view of the metal layers L1 and/or L2). The metal layer L2 may include openings 28 and signal transmission lines 30 arranged between the openings 28, so that the planar transmission lines 26A, 26B may be formed. Each of the planar transmission lines 26A, 26B may be configured to transmit RF signals between the chip (see “to chip”) and the coupling structure, wherein the RF signals transmitted by the planar transmission lines 26A, 26B may be associated with different RF channels of the RF chip 2. In the illustrated example, the planar transmission lines 26A, 26B may have a similar geometry and similar transmission parameters. Due to their orthogonal arrangement, a mode of the first planar transmission line 26A transmitting the first RF signal may be orthogonal to a mode of the second planar transmission line 26B transmitting the second RF signal. The structure may be configured to couple the two RF signals from the planar transmission lines 26A, 26B to two orthogonal modes of a package-external waveguide.

In FIG. 2C, a top view of via connections 10 extending between the metal L3 of FIG. 2A and the metal layer L2 of FIG. 2B is illustrated. The via connections 10 may extend through the dielectric material 8 of the substrate 4 and may be arranged in form of a rectangle or square surrounding the opening 14 and the metal element 22 arranged therein.

Referring now to FIG. 3A, a cross-sectional side view of a system (or RF system) 300 in accordance with the disclosure is shown. The system 300 may include an RF device 100, which may be similar to the RF device 100 of FIG. 1 and may include some or all features of it. The system 300 may include a printed circuit board (PCB) 32, wherein the RF device 100 may be mounted on the top surface of the PCB 32. A mechanical and electrical connection between a substrate 4 of the RF device 100 and the top surface of the PCB 32 may be established by multiple electrical connections elements 16 arranged at the bottom surface of the substrate 4, such as e.g., solder balls or solder depots. It is to be noted that the internal structure of the substrate 4 is only qualitatively indicated, but may in particular be similar to that discussed in connection with FIG. 1A-1E. The PCB 32 may include one or multiple quad ridge waveguides 34 extending through the PCB 32 from the top surface to the bottom surface in a substantially vertical direction. The quad ridge waveguides 34 may be aligned with structures or openings 14 of the RF device 100 arranged at the bottom surface of the substrate 4. Each of the structures or openings 14 may be coupled to at least two RF ports of the RF chip 2 as previously described in connection with the example of FIGS. 1A-1E.

The system 300 may include a package-external waveguide, which may be arranged at the bottom surface of the PCB 32. In the illustrated example, the package-external waveguide may include or may correspond to a waveguide antenna 36 mounted on the bottom surface of the PCB 32. Stated differently, the RF device 100 may be coupled to a first upper end of the waveguide antenna 36 via the PCB 32. The waveguide antenna 36 may include a plurality of air-filled waveguides 38 formed therein. In one example, the waveguide antenna 36 may include or may correspond to an air-filled plastic waveguide antenna. Similar to the openings 14 of the RF device 100 the air-filled waveguides 38 of the waveguide antenna 36 may be aligned with the quad ridge waveguides 34 of the PCB 32. As a result, each of the air-filled waveguides 38 facing the bottom surface of the PCB 32 may be arranged opposite to a structure or opening 14 facing the top surface of the PCB 32.

The PCB 32 and/or the waveguide antenna 36 may be seen as a package-external waveguide into which the structure or opening 14 of the RF device 100 may couple RF signals of the RF chip 2. Each of the structures or openings 14 may be configured to couple at least two RF signals of the RF chip 2 to at least two modes of an opposite quad ridge waveguide 34 of the PCB 32 and/or vice versa. The respective quad ridge waveguide 34 of the PCB 32 connecting the respective opening 14 with the respective opposite air-filled waveguide 38 may be configured for transmitting the at least two modes between the RF device 100 and the package-external waveguide (or more particular between the structure or opening 14 and the air-filled waveguide 38 aligned with the quad ridge waveguides 34).

The waveguide antenna 36 may include a structure (not illustrated) configured to couple two modes of an air-filled waveguide 38 of the waveguide antenna 36 to two RF signals associated with two different antenna elements of the waveguide antenna 36. The structure may be arranged at a second lower end of the waveguide antenna 36. In other words, this structure may be configured to couple an RF signal including two orthogonal modes and transmitted via an air-filled waveguide 38 to two RF signals associated with the two antenna elements of the waveguide antenna 36. For example, the two antenna elements may include or may correspond to two slots formed in the waveguide antenna 36. The two antenna elements may be configured to transmit or radiate the two RF signals. It is to be understood that each of the air-filled waveguides 38 may be associated with a structure as described such that each RF signal including two orthogonal modes and transported via a respective air-filled waveguide 38 may be coupled to two RF signals, which may then be transmitted via the respective two antenna elements.

It is to be noted that the system 300 may be configured to receive RF signals in a similar fashion. In a reception mode, two antenna elements of an air-filed waveguide 38 may receive RF signals and the structure of the waveguide antenna 36 may couple the two received RF signals associated with the two different antenna elements of the waveguide antenna 36 to at least two orthogonal modes of the air-filled waveguide 38. The RF signal including the two orthogonal modes may be forwarded to the respective structure or opening 14 of the RF device 100 arranged opposite to the air-filled waveguide 38. The coupling structure may couple the two orthogonal modes into the RF device 100 as previously described in connection with the example of FIGS. 1A-1E. The waveguide antenna 36 may be configured to transmit and/or receive the two RF signals with a same electromagnetic polarization.

In FIG. 3B, a top view of an interface between a structure or opening 14 of the RF device 100 and a quad ridge waveguide 34 of the PCB 32 is shown. The illustrated components of the RF device 100 have been previously described in connection with FIG. 1C. In the shown case, a cross section of the quad ridge waveguide 34 may have a quad ridge shaped opening similar to the quad ridge shaped opening 14 formed in the metal layer L3 of the RF device 100. That is, the cross section of the quad ridge waveguide 34 may have the shape of a rectangle including a notch in each side of the rectangle. In the illustrated example, the corners and edges of the rectangle and the notches arranged in the sides of the rectangle may be rounded. In particular, the cross section of the quad ridge waveguide 34 of the PCB 32 may be larger than the quad ridge shaped opening 14 of the metal layer L3. In some examples, the contour of the quad ridge shaped opening 14 may be fully arranged in the contour of the quad ridge waveguide 34. The size difference may be configured to provide a matching between the impedance of the package-internal SIWs 12A, 12B and the impedance of the package-external quad ridge waveguide 34.

In FIG. 3C, an arrangement of the connection elements 16 electrically and mechanically connecting the RF device 100 to the top surface of the PCB 32 is shown. The connection elements 16 may surround the quad ridge waveguide 34 of the PCB 32 and the quad ridge shaped opening 14 of the RF device 100. In the illustrated example, an example number of four connection elements 16′ may be arranged between two adjacent ridges of the quad ridge waveguide 34. In further examples, more than only one connection element 16′ may be arranged between the ridges. The electrical connection elements 16 may be configured to provide an electrical shielding for reducing radiation losses when transmitting the RF signals between the opening 14 of the RF device 100 and the quad ridge waveguide 34 of the PCB 32.

In FIG. 3D, a top view of the waveguide antenna 36 at an interface between a quad ridge waveguide 34 of the PCB 32 and an air-filled waveguide 38 of the waveguide antenna 36 is shown. At the interface, the air-filled waveguide 38 may have a quad ridge shaped cross section. The quad ridge shaped opening of the air-filled waveguide 38 may be aligned with a corresponding opposite quad ridge waveguide 34 of the PCB 32. The air-filled waveguide 38 may extend through the plastic housing of the waveguide antenna 36. The inner walls of the air-filled waveguide 38 may be coated with one or more metal layers 40.

Referring now to FIG. 4, a top view of a quad ridge waveguide 34 is shown, as it may e.g., be included in the PCB 32 of FIG. 3A. The waveguide 34 may have a quad ridge shaped cross section including a center portion 42 and four ridge portions 44 arranged at the periphery of the center portion 42. In the illustrated example, the quad ridge waveguide 34 included in the PCB may be formed by five holes extending through the PCB from its top surface to its bottom surface. In particular, the five holes may be manufactured by drilling which may result in a circular shape of each hole. The center portion 42 may be formed by a circular hole having a first diameter. The four ridges portions 44 may be formed by four circular holes having a second diameter smaller than the first diameter. The inner walls of the quad ridge waveguide 34 may be coated by one or more metal layers (not shown).

In FIG. 5, a bottom view of a system 500 in accordance with the disclosure is shown. For example, the system 500 may include some or all features of the system 300 of FIG. 3. Referring back to the example of FIG. 3, the illustrated bottom view may particularly show an arrangement of the air-filled waveguides 38 arranged in the waveguide antenna 36. Each of the air-filled waveguides 38 may include a rectangular or square section 46, which may be aligned with an opposite structure or opening 14 of the RF device 100. From each rectangular section 46, an example number of two elongated sections 48 may branch off via which RF signals may be transmitted to antenna elements of the waveguide antenna as previously described in connection with FIG. 3 (see “to antenna elements”). In the illustrated example, the pairs of elongated sections 48 may be arranged perpendicular or parallel to each other and may be arranged such that a most compact RF interface between the RF device 100, the PCB 32 and the waveguide antenna 36 may be provided.

### ASPECTS

The aspects described herein provide RF devices and systems including RF devices.

Aspect 1 is a radio frequency (RF) device, comprising: at least one RF chip; and a structure coupled to the at least one RF chip, wherein the at least one RF chip and the structure are integrated in a same semiconductor package, wherein the structure is configured to couple at least two RF signals of the at least one RF chip to at least two modes of a package-external waveguide and/or vice versa, wherein the structure comprises: a metal layer comprising an opening, and one or more metal elements arranged in the opening.

Aspect 2 is an RF device according to Aspect 1, wherein the opening is a quad ridge shaped opening.

Aspect 3 is an RF device according to Aspect 2, wherein the quad ridge shaped opening has the shape of a cross section of a quad ridge waveguide.

Aspect 4 is an RF device according to Aspect 2 or 3, wherein the quad ridge shaped opening has the shape of a rectangle comprising a notch in each side of the rectangle.

Aspect 5 is an RF device according to Aspect 4, wherein: the one or more metal elements comprise four metal elements, and each of the four metal elements is arranged in a different corner of the rectangle.

Aspect 6 is an RF device according to any of the preceding Aspects, wherein the one or more metal elements are structured portions of the metal layer.

Aspect 7 is an RF device according to any of the preceding Aspects, wherein the one or more metal elements are separated and electrically isolated from each other.

Aspect 8 is an RF device according to any of the preceding Aspects, wherein each of the one or more metal elements is electrically floating.

Aspect 9 is an RF device according to any of the preceding Aspects, further comprising: at least one package-internal transmission structure coupled between the at least one RF chip and the structure and configured to transmit the at least two RF signals, wherein the structure is configured to couple the at least two RF signals from the at least one package-internal transmission structure to the at least two modes of the package-external waveguide and/or vice versa.

Aspect 10 is an RF device according to Aspect 9, wherein the structure is configured to transform an impedance of the package-internal transmission structure to an impedance of the package-external waveguide.

Aspect 11 is an RF device according to Aspect 9 or 10, wherein the at least one package-internal transmission structure comprises a first package-internal transmission structure extending in a first direction and a second package-internal transmission structure extending in a second direction orthogonal to the first direction.

Aspect 12 is an RF device according to any of Aspects 9 to 11, wherein the at least one package-internal transmission structure comprises at least one of a substrate integrated waveguide, an air-filled waveguide or a planar transmission line.

Aspect 13 is an RF device according to any of Aspects 9 to 12, wherein the package-internal transmission structure comprises an impedance matching element.

Aspect 14 is an RF device according to any of the preceding Aspects, further comprising: a substrate comprising a first main surface and an opposite second main surface, wherein the at least one RF chip is mounted on the first main surface, and wherein the metal layer comprising the opening is arranged in the substrate at the second main surface.

Aspect 15 is an RF device according to any of the preceding Aspects, wherein the at least two RF signals are associated with at least two different RF channels of the at least one RF chip.

Aspect 16 is an RF device according to any of the preceding Aspects, wherein the at least two modes are orthogonal to each other.

Aspect 17 is a system, comprising: an RF device, comprising: at least one RF chip, and a structure coupled to the at least one RF chip, wherein the at least one RF chip and the structure are integrated in a same semiconductor package, wherein the structure is configured to couple at least two RF signals of the at least one RF chip to at least two modes of a package-external waveguide and/or vice versa, wherein the structure comprises a metal layer comprising an opening; and a printed circuit board comprising a first main surface and an opposite second main surface, wherein the RF device is mounted on the first main surface, wherein the printed circuit board comprises a quad ridge waveguide extending through the printed circuit board from the first main surface to the second main surface, wherein the quad ridge waveguide is aligned with the opening of the metal layer.

Aspect 18 is a system according to Aspect 17, wherein the quad ridge waveguide of the printed circuit board is configured to transmit the at least two modes between the RF device and the package-external waveguide.

Aspect 19 is a system according to Aspect 17 or 18, wherein a cross section of the quad ridge waveguide of the printed circuit board is larger than the opening of the metal layer.

Aspect 20 is a system according to any of Aspects 17 to 19, wherein the quad ridge waveguide of the printed circuit board is formed by five drilled holes extending through the printed circuit board from the first main surface to the second main surface.

Aspect 21 is a system according to any of Aspects 17 to 20, further comprising: a plurality of connection elements electrically and mechanically connecting the RF device to the first main surface of the printed circuit board, wherein the connection elements surround the quad ridge waveguide of the printed circuit board, and wherein at least one of the connection elements is arranged between two ridges of the quad ridge waveguide.

Aspect 22 is a system according to any of Aspects 17 to 21, wherein the package-external waveguide comprises a waveguide antenna mounted on the second main surface of the printed circuit board.

Aspect 23 is a system according to Aspect 22, wherein the waveguide antenna comprises a structure configured to couple at least two RF signals associated with at least two different antenna elements of the waveguide antenna to at least two modes of a waveguide of the waveguide antenna and/or vice versa.

Aspect 24 is a system according to Aspect 23, wherein: the waveguide antenna comprises an air-filled plastic waveguide antenna, and the at least two antenna elements comprise at least two slots formed in the plastic waveguide antenna.

Aspect 25 is a system according to any of Aspects 17 to 24, wherein the RF device is an RF device according to any of claims 1 to 16.

Although specific examples have been illustrated and described herein, it will be appreciated by those of ordinary skill in the art that a variety of alternate and/or equivalent implementations may be substituted for the specific aspects shown and described without departing from the scope of the present invention. This application is intended to cover any adaptations or variations of the specific aspects discussed herein. Therefore, it is intended that this invention be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all aspects and implementations outlined in the present document are principally intended expressly to be only for explanatory purposes to help the reader in understanding the principles of the proposed methods and systems. Furthermore, all statements herein providing principles, aspects, and implementations of the invention, as well as specific aspects thereof, are intended to encompass equivalents thereof.

1. A radio frequency (RF) device, comprising:
at least one RF chip; and
a structure coupled to the at least one RF chip, wherein the at least one RF chip and the structure are integrated in a same semiconductor package,
wherein the structure is configured to couple at least two RF signals of the at least one RF chip to at least two modes of a package-external waveguide and/or vice versa,
wherein the structure comprises:
a metal layer comprising an opening, and
one or more metal elements arranged in the opening.

2. The RF device of claim 1, wherein the opening is a quad ridge shaped opening.

3. The RF device of claim 2, wherein the quad ridge shaped opening has the shape of a cross section of a quad ridge waveguide.

4. The RF device of claim 2, wherein the quad ridge shaped opening has the shape of a rectangle comprising a notch in each side of the rectangle.

5. The RF device of claim 4, wherein:
the one or more metal elements comprise four metal elements, and
each of the four metal elements is arranged in a different corner of the rectangle.

6. The RF device of claim 1, wherein the one or more metal elements are structured portions of the metal layer.

7. The RF device of claim 1, wherein the one or more metal elements are separated and electrically isolated from each other.

8. The RF device of claim 1, wherein each of the one or more metal elements is electrically floating.

9. The RF device of claim 1, further comprising:
at least one package-internal transmission structure coupled between the at least one RF chip and the structure and configured to transmit the at least two RF signals,
wherein the structure is configured to couple the at least two RF signals from the at least one package-internal transmission structure to the at least two modes of the package-external waveguide and/or vice versa.

10. The RF device of claim 9, wherein the structure is configured to transform an impedance of the package-internal transmission structure to an impedance of the package-external waveguide.

11. The RF device of claim wherein the at least one package-internal transmission structure comprises a first package-internal transmission structure extending in a first direction and a second package-internal transmission structure extending in a second direction orthogonal to the first direction.

12. The RF device of claim 9, wherein the at least one package-internal transmission structure comprises at least one of a substrate integrated waveguide, an air-filled waveguide or a planar transmission line.

13. The RF device of claim 9, wherein the package-internal transmission structure comprises an impedance matching element.

14. The RF device of claim 1, further comprising:
a substrate comprising a first main surface and an opposite second main surface,
wherein the at least one RF chip is mounted on the first main surface, and
wherein the metal layer comprising the opening is arranged in the substrate at the opposite second main surface.

15. The RF device of claim 1, wherein the at least two RF signals are associated with at least two different RF channels of the at least one RF chip.

16. The RF device of claim 1, wherein the at least two modes are orthogonal to each other.

17. A system, comprising:
an RF device, comprising:
at least one RF chip, and
a structure coupled to the at least one RF chip, wherein the at least one RF chip and the structure are integrated in a same semiconductor package,
wherein the structure is configured to couple at least two RF signals of the at least one RF chip to at least two modes of a package-external waveguide and/or vice versa,
wherein the structure comprises a metal layer comprising an opening; and
a printed circuit board comprising a first main surface and an opposite second main surface,
wherein the RF device is mounted on the first main surface,
wherein the printed circuit board comprises a quad ridge waveguide extending through the printed circuit board from the first main surface to the opposite second main surface,
wherein the quad ridge waveguide is aligned with the opening of the metal layer.

18. The system of claim 17, wherein the quad ridge waveguide of the printed circuit board is configured to transmit the at least two modes between the RF device and the package-external waveguide.

19. The system of claim 17, wherein a cross section of the quad ridge waveguide of the printed circuit board is larger than the opening of the metal layer.

20. The system of claim 17, wherein the quad ridge waveguide of the printed circuit board is formed by five drilled holes extending through the printed circuit board from the first main surface to the opposite second main surface.

21. The system of claim 17, further comprising:
a plurality of connection elements electrically and mechanically connecting the RF device to the first main surface of the printed circuit board,
wherein the connection elements surround the quad ridge waveguide of the printed circuit board, and
wherein at least one of the connection elements is arranged between two ridges of the quad ridge waveguide.

22. The system of claim 17, wherein the package-external waveguide comprises a waveguide antenna mounted on the opposite second main surface of the printed circuit board.

23. The system of claim 22, wherein the waveguide antenna comprises a structure configured to couple at least two RF signals associated with at least two different antenna elements of the waveguide antenna to at least two modes of a waveguide of the waveguide antenna and/or vice versa.

24. The system of claim 23, wherein:
the waveguide antenna comprises an air-filled plastic waveguide antenna, and
the at least two different antenna elements comprise at least two slots formed in the air-filled plastic waveguide antenna.

25. (canceled)
